(19) United States
(12) Patent Application Publication
(10) Pub. No.: US 2023/0089686 A1
(43) Pub. Date: Mar. 23, 2023

(54) SYSTEM AND METHOD FOR CONFIGURATION OF WIRELESS NETWORK DEVICE

(71) Applicant: Treon Oy, Tampere (FI)

(72) Inventors: Joni Korppi, Lempäälä (FI); Jari Toivanen, Tampere (FI); Ismo Manninen, Tampere (FI)

(73) Assignee: Treon Oy, Tampere (FI)

(21) Appl. No.: 17/944,835

(22) Filed: Sep. 14, 2022

(30) Foreign Application Priority Data
Sep. 17, 2021 (FI) 20215981

(51) Int. Cl. H04L 41/0803; H04W 8/24

(52) U.S. Cl. CPC H04L 41/0803; H04W 8/245

(57) ABSTRACT

A system for configuring a wireless network device. The system includes the wireless network device which further includes a wireless radio processing unit having a first memory and a radio frequency circuit having a second memory. The wireless radio processing unit has a first configuration data pre-programmed in the first memory. The radio frequency circuit is configured to be powered using energy harvesting, and to receive a second configuration data pertaining to the wireless network device in the second memory from an external computing device.

### TECHNICAL FIELD

The present disclosure relates generally to wireless network devices; and more specifically, to systems and methods for configuration of wireless network devices.

### BACKGROUND

With advancements in technology, various types of wireless network devices or Internet of Things (IoT) devices and their broad spectrum of applications have become an integral part of our modern-day lifestyle. Their applications ranging from smart cities, smart environment, water management, smart metering, security and emergencies, supply chain management, industrial control, smart agriculture, animal farming, commercial and domestic automations, e-health and so forth. Notably, people interact with a number of different electronic devices on a daily basis. Services provided by such wireless network devices are easily accessible at any location in the world via an internet connection, making our lifestyles more comforting and time efficient. In a home setting, for example, a person may interact with computers, smart televisions, tablets, smart thermostats, lighting systems, alarm systems, entertainment systems, and a variety of other electronic devices. Additionally, people feel uncomfortable in an unknown environment, e.g., hotel room, friend's house they are visiting. The sense of uncomfortableness, unfamiliarity, or disconnection is increased when the unknown environment has different room temperature settings, light preferences, device configurations from the preferential settings in such people's home environment.

Typically, most of the wireless network devices available for the users come with their own predefined factory configurations and default settings. Additionally, the wireless network devices start working with the default settings from the manufacturer when powered ON for the first time. Moreover, the default settings can be later modified by users as per their requirements and needs. Furthermore, in real life scenarios, there might be instances where some users or in few cases some industries might need some of the wireless network devices to work according to their own custom configurations right from the time these devices are first installed and powered ON. Notably, the wireless network devices do not have a physical ON and OFF switch as they are used in remote locations and physically turning them ON and OFF is not feasible. Moreover, physical switches are difficult to maintain and keep in operation in a dirty industrial environment. Consequently, configuring the wireless network devices gets difficult without a power switch. Additionally, wireless network devices with battery tend to decrease the battery life if powered ON during configuration as the devices might be months away from actual shipping and installation.

Although, there have been some solutions proposed in context of making customized modification to the configurations of the wireless network devices according to the user. Moreover, these solutions include ecosystems of one or more wireless network devices interconnected with each other and sharing the user's past experiences, likes and dislikes among them, and based on this shared information they make the modifications to their configurations, rather than letting the user make the necessary modifications before the device is first installed for use. Furthermore, none of these solutions provide an efficient way of encrypting and decrypting the modifications to be made in the wireless network device providing a secure environment.

Therefore, in light of the foregoing discussion, there exists a need to overcome the aforementioned drawbacks associated with configuring a wireless network device.

### SUMMARY

The present disclosure seeks to provide a system for configuring a wireless network device. The present disclosure also seeks to provide a method for configuring a wireless network device. An aim of the present disclosure is to provide a solution that overcomes at least partially the problems encountered in prior art.

In one aspect, the present disclosure provides a system for configuration of a wireless network device, the system comprising: the wireless network device comprising a wireless radio processing unit having a first memory; and a radio frequency circuit having a second memory; wherein the wireless radio processing unit has a first configuration data pre-programmed in the first memory thereof, and wherein the radio frequency circuit is configured to be powered using energy harvesting, and to receive a second configuration data pertaining to the wireless network device in the second memory from an external computing device.

In another aspect, the present disclosure provides a method for configuration of a wireless network device, the method comprising powering a radio frequency circuit of the wireless network device using energy harvesting, wherein the wireless network device comprises a wireless radio processing unit having a first configuration data pre-programmed in the first memory thereof; and receiving a second configuration data pertaining to the wireless network device in the second memory from an external computing device.

Embodiments of the present disclosure substantially eliminate or at least partially address the aforementioned problems in the prior art, and enable pre-configuration of wireless network device before installation. Beneficially, the present disclosure eliminates requirement of an ecosystems of one or more wireless network devices interconnected with each other.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIGS. 1-3 are schematic illustrations of a system for configuration of a wireless network device, in accordance with different embodiments of the present disclosure;

FIG. 4 is an environment in which the system for configuration of a wireless network device is implemented, in accordance with an embodiment of the present disclosure; and

FIG. 5 is a flowchart depicting steps of a method for configuration of a wireless network device, in accordance with an embodiment of the present disclosure.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a system for configuration of a wireless network device, the system comprising: the wireless network device comprising a wireless radio processing unit having a first memory; and a radio frequency circuit having a second memory; wherein the wireless radio processing unit has a first configuration data pre-programmed in the first memory thereof, and wherein the radio frequency circuit is configured to be powered using energy harvesting, and to receive a second configuration data pertaining to the wireless network device in the second memory from an external computing device.

In another aspect, an embodiment of the present disclosure provides a method for configuration of a wireless network device, the method comprising powering a radio frequency circuit of the wireless network device using energy harvesting, wherein the wireless network device comprises a wireless radio processing unit having a first configuration data pre-programmed in the first memory thereof; and receiving a second configuration data pertaining to the wireless network device in the second memory from an external computing device.

The system and method of the present disclosure aims to provide a setup for configuration of a wireless network device. Notably, the present disclosure does not require any changes in the manufacturing of the wireless network device and user specific configuration will be done just before shipping or installation. Additionally, the present disclosure does not require the wireless network device to be powered up for configuration thereof. Furthermore, wireless network devices comprising a battery will have longer battery life as the devices will not be activated until real use starts.

Pursuant to embodiments of the present disclosure, there is provided the system and the method for configuration of a wireless network device. Herein, the term “configuration” refers to programming data relating to the wireless network device therein. Notably, the configuration data is either read data or write data. Herein, read data includes all the pre-programmed data linked to the wireless network device at the time of manufacturing. This includes ID, date/time, location, battery status and the like. Alternatively, write data includes but is not limited to, sensor specific data, addresses, keys, operating parameters, client specific customization data, network parameters, password certificates, sensor specific time intervals, light colour maps, brightness level. Furthermore, in case the wireless network device is battery dead, the read data (ID) can be used even if the target device has no power.

The system comprises a wireless network device. Herein, the term “wireless network device” refers to a computing device with the ability to connect wirelessly to a network and transmit data over the network. Additionally, wireless network devices are embedded with programmable and non-programmable components such as sensors, can communicate and interact over the internet and can also be remotely monitored and controlled. Furthermore, wireless network devices may include, but are not limited to, IoT devices, network devices, internet enabled devices and so forth.

The system comprises a wireless radio processing unit having a first memory. Herein, the term “wireless radio processing unit” refers to a computational element capable of receiving data via radio waves or a wired connection for controlling operation thereof and of the wireless network device. Furthermore, the first memory refers to any non-volatile memory (NVM) or non-volatile storage that can retain stored information even after a power source is removed. Additionally, the first memory includes, but is not limited to, flash memory, read-only memory (ROM), ferroelectric RAM, hard disk drives, floppy disks, and magnetic tape, optical discs. Moreover, the wireless radio processing unit having the first memory is located inside the wireless network device.

The system comprises a radio frequency (RF) circuit having a second memory. Herein, the term “radio frequency circuit” refers to a circuit that can capture and convert electromagnetic energy into a usable continuous voltage (DC). Notably, the radio frequency circuit comprises an antenna and a rectifier circuit that allows conversion of electromagnetic energy received via an electromagnetic signal to usable voltage. Moreover, the second memory refers to any non-volatile memory (NVM) or non-volatile storage that can retain stored information even after power is removed. Furthermore, the radio frequency circuit having the second memory is located inside the wireless network device.

The wireless radio processing unit has a first configuration data pre-programmed in the first memory. Herein, the first configuration data refers to default operational settings for the wireless network device. Notably, the first configuration data may be pre-programmed, for example, in a factory by a manufacturer or it can be zero data i.e., whole bytes in memory written FFFF or 0000. It will be appreciated that the first configuration data is not user-specific or customised based on user requirements, and corresponds to predefined general operational settings.

The radio frequency circuit is configured to be powered using energy harvesting. Herein, the term “energy harvesting” refers to the process by which energy is captured from electromagnetic waves and stored for tasks that require small amounts of electricity. Small amounts of electricity means absorbed power below 200 mW at 7.5 A/m that may be used for powering up the radio frequency circuit for configuring to receive a second configuration data from an external computing device and to write the second configuration data in the second memory of the radio frequency circuit. E.g., small amounts may thus be 190, 185, 180, 175, 170, 165, 160, 155, 150, 145, 140, 135, 130, 125, 120, 115, 110, 105, 100, 95, 90, 85, 80, 75, 70, 65, 60, 55, 50, 45, 40, 35, 30, 25 or 20 mW. In addition, small amounts of electricity may be used parallel or separately for powering up the wireless radio processing unit for configuring to receive the configuration data from the second memory of the radio frequency circuit into the first memory of the wireless radio processing unit for configuration of the wireless radio processing unit. Notably, energy harvesting provides a very small amount of power below 20 mW at 7.5 A/m for low-energy electronics such as Near-Field Communication (NFC) tags. E.g., very small amount of power may thus be 19, 18, 17, 16, 15, 14, 13, 12, 11, 10, 9, 8, 7, 6, 5, 4, 3, 2 or 1 mW NFC tags are unpowered NFC chips that draw power from a nearby smartphone or other powered NFC device. They don't need their own battery or source of power. The radio frequency circuit enables the wireless network device to receive information even when the wireless network device has no power. The radio frequency circuit is configured to receive a second configuration data pertaining to the wireless network device in the second memory from an external computing device. Herein, the second configuration data is user-specific, application-specific or network-specific configuration data. Notably, the second configuration data enables the user to deploy and to operate the wireless network device according to personally customised operational settings when the wireless network device is powered up. Moreover, the second configuration data can be application or device specific e.g., to enable specific colour configuration with wireless controllable lamps. The radio frequency circuit enables energy harvesting, thereby enabling communication of second configuration data from the external computing device to the radio frequency circuit even when the wireless network device has no power, or in a case if a battery is dead. Beneficially, the radio frequency circuit enables production of a generic wireless network device during the manufacturing process and customizing the wireless network device according to customer specific configuration prior to shipping or installation. Herein, the electromagnetic waves used for energy harvesting include but is not limited to 2G, 3G, 4G, 5G, 6G, radio waves and near-field communication (NFC).

Throughout the present disclosure, the term “external computing device” refers to an electronic device associated with (or used by) a user that enables the user to communicate second configuration data to the radio frequency circuit. Herein, the external computing device is intended to be broadly interpreted to include any electronic device that may be used for voice and/or data communication over a wireless communication network. Moreover, there is a handshaking between the radio frequency circuit and the external computing device making sure lossless second configuration data transmission to the radio frequency circuit. Examples of external computing device include, but are not limited to, cellular phones, personal digital assistants (PDAs), handheld devices, wireless modems, laptop computers, personal computers. Notably, the external computing device is configured to generate the electromagnetic waves required for energy harvesting in the radio frequency circuit.

In an exemplary implementation, the external computing device receives the second configuration data from a remote server connected to external computing device. The remote server may be a single hardware server or plurality of hardware servers operating in a parallel or distributed architecture. In an example, the remote server may be a cloud server. Additionally, or alternatively, the external computing device comprises an application programming interface executable thereon that allows a user to program and/or change the second configuration data according to preferences thereof. The application programming interface may further enable communication of second configuration data between the remote server, the external computing device and the radio frequency circuit. Moreover, the remote server may be affiliated to a verified entity (such as, the manufacturer of the wireless network device), wherein the user of the external computing device may receive the second configuration data from such remote server upon authentication by the verified entity. The remote server may be installed in a physical establishment (such as, a retail store). Optionally, the second configuration data received from the remote server is encrypted, wherein the external computing device is configured to decrypt the encrypted second configuration data.

In an embodiment, the wireless radio processing unit is configured to be powered using energy harvesting and to receive the second configuration data from the second memory of the radio frequency circuit to the first memory, for configuration of the wireless radio processing unit. Herein, the wireless network device is powered up with energy harvesting and the configuration data is stored securely in the first memory. Furthermore, the electromagnetic waves for energy harvesting in the wireless radio processing unit may be received from the external computing device or another source. As mentioned previously, the wireless radio processing unit controls operation of the wireless network device. Therefore, after receiving the second configuration data from the second memory of the radio frequency circuit, the wireless radio processing unit is configured to operate the wireless network device based on the second configuration data stored in the first memory thereof. Beneficially, such communication of second configuration data using energy harvesting and consequent configuration process is faster and more energy efficient than in conventional systems requiring un-packing the wireless network device e.g., in a production, in a shop and so forth, and does not require the wireless network device to be powered, thereby ensuring power efficiency of the system compared to conventional systems requiring internal battery or external power connection for a configuration process. Optionally generic devices e.g., wireless controllable lamps, can be sold wherein the lamp has a general configuration data stored. Configuration of the lamp can take place during the installation process in a new building even when there is no power in the building yet. When the building has electricity and the lamp is powered up the lamp will start with the configuration parameters set during the installation process.

In another embodiment, the wireless radio processing unit is configured to be powered using an external power source and to receive the second configuration data from second memory of the radio frequency circuit to the first memory, for configuration of the wireless radio processing unit. Herein, the external power source may be an alternating current (AC) source, a battery and the like. Notably, the second configuration data comprising e.g., wireless network parameters, Bluetooth pairing parameters, user authentication information and so forth, is written from the second memory of the radio frequency circuit into the first memory of the wireless radio processing unit when the device is powered. Furthermore, the external power source may be disconnected from the wireless radio processing unit after configuration thereof. It will be appreciated that the second configuration data is written immediately during power-up cycle of the wireless radio processing unit and does not require additional time-consuming reboots, further increasing power efficiency of the system.

Optionally, the second configuration data comprises only changed configuration information that is different from the first configuration data leaving e.g., an application specific configuration data such as light intensity, light colour of a wireless controllable lamp to default values. Notably, only the changed configuration information, e.g., wireless network ID, wireless channel, wireless transmit power and so forth, is transferred from the external computing device into the second memory of the radio frequency circuit, and then from the second memory to the first memory. In an example, the first configuration data comprises information relating to 100 parameters in 100 memory addresses relating to operation of the wireless network device. In such example, while customizing the second configuration data, the user only changed 15 parameters in 15 memory addresses, leaving the remaining 85 parameters in 85 memory addresses in their original values. Therefore, in such instance only 15 parameters in 15 memory addresses are communicated from the external computing device as second configuration data to the second memory of the radio frequency circuit and subsequently, to the first memory of the wireless radio processing unit. Beneficially, transferring only the changed configuration information allows faster configuration, shorter time of radio communication, memory saving and power saving compared to the situation when all 100 parameters are communicated from the external computing device as second configuration data to the second memory of the radio frequency circuit. Furthermore, the second configuration data comprises configuration information that is typically different from the first configuration data but in an event of a malfunction of the device or when trying to reset the device, same information as the first configuration data may also be provided.

In an embodiment, the second configuration data is encrypted, and wherein the second configuration data is decrypted in the second memory of the radio frequency circuit prior to communication to the first memory of the wireless radio processing unit. Herein, the configuration data sent by the external computing device to the second memory of the radio frequency device is encrypted. Notably, powering the wireless radio processing, the encrypted configuration data is decrypted in the second memory of the radio frequency circuit and communicated to the first memory. Additionally, decryption information is stored in the second memory and as a result, additional information transfer relating to decryption, via a different radio channel is not required. Furthermore, storing decryption keys in second memory enables simpler implementation of the wireless radio processing unit while allocating more processing for the RF circuit. Moreover, encrypting the data configuration makes it secure and safe.

In another embodiment, the second configuration data is encrypted, and wherein the second configuration data is decrypted in the first memory of the wireless radio processing unit after receiving from the second memory of the radio frequency circuit. Notably, the configuration data received by the second memory in the radio frequency circuit from the external computing device is encrypted. Additionally, when the wireless network device is powered, the encrypted configuration data is written into the first memory and decrypted there. Moreover, decryption information is stored in the first memory and as a result, additional information transfer relating to decryption, via a different radio channel is not required. Notably, the decryption of the configuration data can take place in a wireless radio processing unit or a radio frequency circuit unit which are situated in the wireless network unit. Furthermore, encrypting the configuration data makes it secure and ensures integrity.

Optionally, the wireless network device further comprises a battery connected to the radio frequency circuit and the wireless radio processing unit via a switch, and wherein the radio frequency circuit is configured to turn on the switch during configuration phase of the wireless radio processing unit. Herein, the battery connects the wireless radio processing unit and the radio frequency circuit to allow communication from the second memory to the first memory. Additionally, the switch connects the battery to the wireless radio frequency unit and the radio frequency circuit. Moreover, the radio frequency circuit turns ON the switch at the time of configuring the wireless radio processing unit. Furthermore, turning ON the switch starts the actual configuration process. Notably, the switch acts as a protective tab in conventional systems that is commonly present in between a battery and an electronic component. The term “protective tab” refers to a mechanical arrangement in conventional systems separating a battery and electronic components when not in use or when a battery operating device is in a storage after manufacturing wherein the protective tab prolongs the lifespan of the battery. Beneficially, the switch ensures that the battery is only connected to the radio frequency circuit and the wireless radio processing unit when in use, thereby ensuring that the battery is not depleted during storage or shipping. Such selective use of the battery allows for longer-term viability of the wireless network devices between a time of manufacturing of the device to the time of installation and subsequent use thereof wherein the use of a battery is started until a real use of the wireless network device has begun. Furthermore, production of the wireless network device is faster and efficient as there is no need to add a separate protective tab during manufacturing, further enabling easier and safer packaging and contributing to overall energy savings during manufacturing with a faster production cycle wherein there is no need to open packaged wireless network devices in the store if reconfigurations are needed.

Optionally, the radio frequency circuit is further configured to turn off the switch after configuration of the wireless radio processing unit is complete. Notably, the radio frequency (NFC) circuit is used as a button to turn ON and turn OFF the switch. In an example, the NFC reader activates and deactivates the switch and provides the ON and OFF functionality in the wireless radio processing unit. Additionally, the RF circuit turns OFF the switch after the configuration data is received by the first memory from the second memory and the configuration process is completed and confirmed with a handshaking between the radio frequency circuit and the wireless radio processing unit. If the configuration process is not completed the handshaking between the radio frequency circuit and the wireless radio processing unit initiates a retransmission of the configuration data until the configuration process is completed. Moreover, turning OFF the switch after transfer of configuration data increases the battery life and also saves other components from internal short circuits. Furthermore, a physical ON and OFF switch is difficult to keep in operation in a dirty industrial environment.

In an optional embodiment, the wireless network device further comprises a controlling unit electronics. Herein, the term “controlling unit electronics” refers to any electronic device or appliance or the like, which has the scope to connect to the Wi-Fi and interact with other devices on the same home network. Additionally, controlling unit electronics may include, but are not limited to, wireless sensors, home locks, car locks, smart lamps or smart lamps, smoke detectors, coffee makers, freezers and so forth. Furthermore, the controlling unit electronics is connected to the external power source for powering up and receives configuration data from the wireless radio processing unit. Moreover, the controlling unit electronics maybe integrated to the wireless radio processing unit. This allows device configuration in parallel to network parameter configuration. In an example, smart lamp data configuration in parallel with the network parameter configuration is possible.

The present disclosure also relates to the method as described above. Various embodiments and variants disclosed above apply mutatis mutandis to the method.

Optionally, the method further comprises powering the wireless radio processing unit using energy harvesting and receiving the second configuration data from second memory of the radio frequency circuit to the first memory, for configuration of the wireless radio processing unit.

Optionally, the method further comprises powering the wireless radio processing unit using an external power source and receiving the second configuration data from second memory of the radio frequency circuit to the first memory, for configuration of the wireless radio processing unit.

Optionally, the method comprises receiving the second configuration data encrypted, and wherein the method further comprises decrypting the second configuration data in the second memory of the radio frequency circuit prior to communicating the second configuration data to the first memory of the wireless radio processing unit.

Optionally, the method comprises receiving the second configuration data encrypted, and wherein the method further comprises decrypting the second configuration data in the first memory of the wireless radio processing unit after receiving the second configuration data from the second memory of the radio frequency circuit.

Optionally, the method comprises receiving the second configuration data comprising only changed configuration information that is different from the first configuration data.

Optionally, the wireless network device further comprises a battery connected to the radio frequency circuit and the wireless radio processing unit via a switch, and wherein the method comprises configuring the radio frequency circuit to turn on the switch during configuration phase of the wireless radio processing unit.

Optionally, the method comprises configuring the radio frequency circuit to turn off the switch after configuration of the wireless radio processing unit is complete.

The present disclosure further provides a computer program for configuration of a wireless network device comprising instructions which when the computer program is executed by a system comprising an external computing device, cause the system to perform the aforementioned method.

### DETAILED DESCRIPTION OF THE DRAWINGS

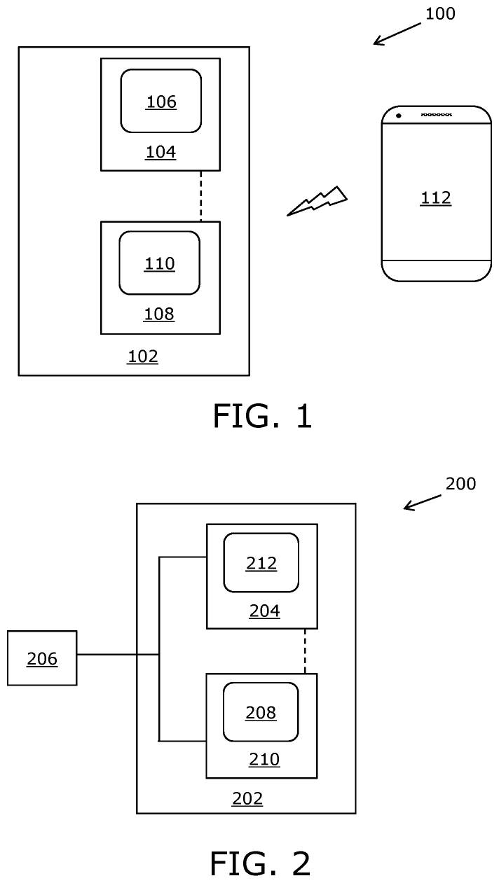

Referring to FIG. 1, illustrated is a schematic illustration of a system 100 for configuration of a wireless network device 102 in accordance with an embodiment of the present disclosure. The wireless network device 102 comprises a wireless radio processing unit 104 having a first memory 106 and a radio frequency (RF) circuit 108 having a second memory 110. Further, the radio frequency circuit 108 is configured to receive a second configuration data pertaining to the wireless network device 102 in the second memory 110 from an external computing device 112. Herein, a dotted line between the wireless radio processing unit 104 and radio frequency circuit 108 represents data connection therebetween.

Referring to FIG. 2, illustrated is a schematic illustration of a system 200 for configuration of a wireless network device 202, in accordance with an embodiment of the present disclosure. The wireless radio processing unit 204 is configured to be powered using an external power source 206 and to receive the second configuration data from second memory 208 of the radio frequency circuit 210 to the first memory 212, for configuration of the wireless radio processing unit 204. Herein, a dotted line represents data connection and solid lines represent power connections.

Referring to FIG. 3, illustrated is a schematic illustration of a system 300 for configuration of a wireless network device 302, in accordance with an embodiment of the present disclosure. The wireless network device 302 further comprises a battery 304 connected to the radio frequency circuit 306 and the wireless radio processing unit 308 via a switch 310, and wherein the radio frequency circuit 306 is configured to turn on the switch 310 during configuration phase of the wireless radio processing unit 308. The radio frequency circuit 306 is further configured to turn off the switch 310 after configuration of the wireless radio processing unit 308 is complete. Herein, the dotted lines represent data connections and solid lines represent power connections.

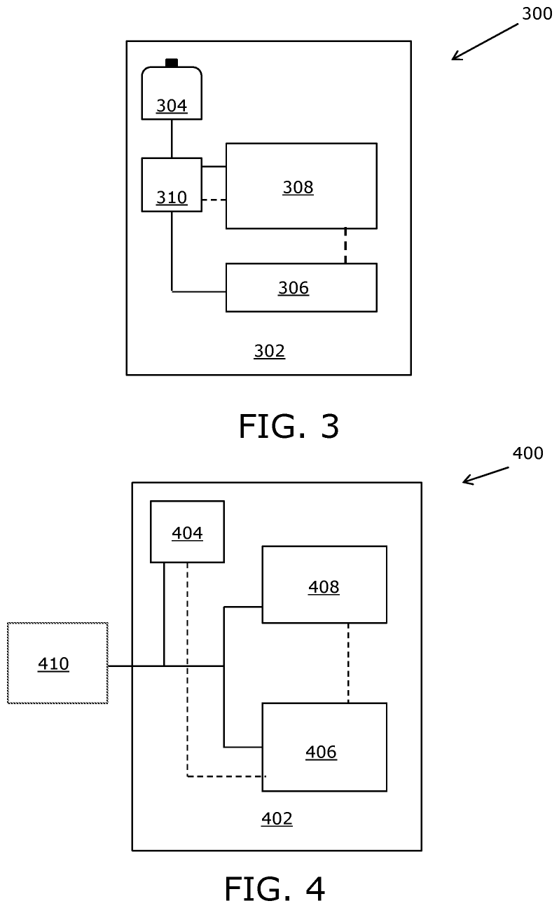

Referring to FIG. 4, illustrated is an environment in which the system 400 for configuration of a wireless network device 402 is implemented, in accordance with an embodiment of the present disclosure. The system 400 further comprises a controlling unit electronics 404 communicably coupled with the radio frequency circuit 406 and the wireless radio processing unit 408. Herein, the controlling unit electronics 404 may include, but are not limited to, smart lamps, smoke detectors, coffee makers, freezers and so forth. The controlling unit electronics 404 is connected to the external power source 410 for powering up and receives configuration data from the wireless radio processing unit 408. Herein, the dotted lines represent data connections and solid lines represent power connections.

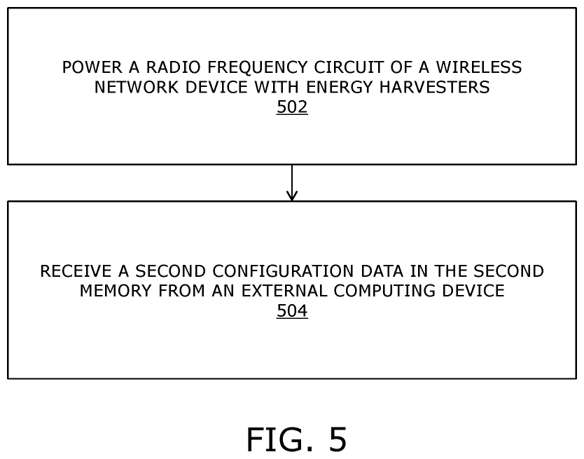

Referring to FIG. 5, illustrated is a flowchart depicting steps of a method for configuration of a wireless network device in accordance with an embodiment of the present disclosure. At a step 502, a radio frequency circuit of the wireless network device is powered using energy harvesting. At a step 504, a second configuration data pertaining to the wireless network device is received in the second memory from an external computing device.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A system for configuration of a wireless network device, the system comprising:
the wireless network device comprising
a wireless radio processing unit having a first memory; and
a radio frequency circuit having a second memory;
wherein the wireless radio processing unit has a first configuration data pre-programmed in the first memory thereof, and
wherein the radio frequency circuit is configured to be powered using energy harvesting, and to receive a second configuration data pertaining to the wireless network device in the second memory from an external computing device.

2. The system of claim 1, wherein the wireless radio processing unit is configured to be powered using energy harvesting and to receive the second configuration data from the second memory of the radio frequency circuit to the first memory, for configuration of the wireless radio processing unit.

3. The system of claim 1, wherein the wireless radio processing unit is configured to be powered using an external power source and to receive the second configuration data from second memory of the radio frequency circuit to the first memory, for configuration of the wireless radio processing unit.

4. The system of claim 2, wherein the second configuration data is encrypted, and wherein the second configuration data is decrypted in the second memory of the radio frequency circuit prior to communication to the first memory of the wireless radio processing unit.

5. The system of claim 2, wherein the second configuration data is encrypted, and wherein the second configuration data is decrypted in the first memory of the wireless radio processing unit after receiving from the second memory of the radio frequency circuit.

6. The system of claim 1, wherein the second configuration data comprises only changed configuration information that is different from the first configuration data.

7. The system of claim 1, wherein the wireless network device further comprises a battery connected to the radio frequency circuit and the wireless radio processing unit via a switch, and wherein the radio frequency circuit is configured to turn on the switch during configuration phase of the wireless radio processing unit.

8. The system of claim 7, wherein the radio frequency circuit is further configured to turn off the switch after configuration of the wireless radio processing unit is complete.

9. A method for configuration of a wireless network device, the method comprising:
powering a radio frequency circuit of the wireless network device using energy harvesting, wherein the wireless network device comprises a wireless radio processing unit having a first configuration data pre-programmed in the first memory thereof; and
receiving a second configuration data pertaining to the wireless network device in the second memory from an external computing device.

10. The method of claim 9, wherein the method further comprises powering the wireless radio processing unit using energy harvesting and receiving the second configuration data from the second memory of the radio frequency circuit to the first memory, for configuration of the wireless radio processing unit.

11. The method of claim 9, wherein the method further comprises powering the wireless radio processing unit using an external power source and receiving the second configuration data from second memory of the radio frequency circuit to the first memory, for configuration of the wireless radio processing unit.

12. The method of claim 10, wherein the method comprises receiving the second configuration data encrypted, and wherein the method further comprises decrypting the second configuration data in the second memory of the radio frequency circuit prior to communicating the second configuration data to the first memory of the wireless radio processing unit.

13. The method of claim 10, wherein the method comprises receiving the second configuration data encrypted, and wherein the method further comprises decrypting the second configuration data in the first memory of the wireless radio processing unit after receiving the second configuration data from the second memory of the radio frequency circuit.

14. The method of claim 10, wherein the method comprises receiving the second configuration data comprising only changed configuration information that is different from the first configuration data.

15. The method of claim 10, wherein the wireless network device further comprises a battery connected to the radio frequency circuit and the wireless radio processing unit via a switch, and wherein the method comprises configuring the radio frequency circuit to turn on the switch during configuration phase of the wireless radio processing unit.

16. The method of claim 14, wherein the method comprises configuring the radio frequency circuit to turn off the switch after configuration of the wireless radio processing unit is complete.

17. A computer program product for configuration of a wireless network device comprising non-transitory machine readable instructions which when executed by a system comprising an external computing device, cause the system to perform the method of claim 9.
